(19) United States
(12) Patent Application Publication
(10) Pub. No.: US 2011/0248029 A1
(43) Pub. Date: Oct. 13, 2011

(54) SPRING COLLECTOR BOX

(76) Inventor: Eric Steven Gray, Enterprise, OR (US)

(21) Appl. No.: 12/906,059

(22) Filed: Oct. 15, 2010

Related U.S. Application Data
(60) Provisional application No. 61/252,087, filed on Oct. 15, 2009.

(51) Int. Cl. B65D 6/28; B23P 19/00

(52) U.S. Cl. 220/4.01; 29/428

(57) ABSTRACT

A pre-fabricated spring box, preferably of stainless steel, has a stepped top, with a closed top back portion, and an open top front portion, which front portion is covered and sealed by a snug hinged lid. The box is preferably constructed of medium gauge brushed stainless steel. The bottom of the box has an opening that is slightly smaller than the bottom. There is an identically sized opening in the back of the box near the bottom. A stainless steel panel of the size required to cover one of these openings is provided. The front of the box has three threaded couplers welded in place for a bottom drain line, an outlet supply line and an overflow line.

This application claims priority from my prior pending U.S. Provisional Patent Application No. 61/252,087, filed on Oct. 15, 2010, and entitled “Spring Box”, the disclosure of which is incorporated herein by reference.

### BACKGROUND OF THE INVENTION

1. Field of the Invention

This invention relates generally to spring water collection for distribution to users. More specifically, this invention relates to a stainless steel spring collector box that may be economically pre-fabricated for convenient installation, even at remote or relatively inaccessible sites.

2. Related Art

U.S. Pat. No. 3,559,408 (Earnhart) discloses a spring development system with a spring collector box and a storage tank.

U.S. Pat. No. 4,700,734 (McCauley) discloses a spring water collecting box and a storage tank. The flow rate of water from the spring box is controlled by varying the height of the water level maintained in the spring box, and by selectively sizing and spacing openings formed in a vertical water filter connected to the supply outlet.

The website www.carolinawatertank.com/springbox.htm discloses a spring water collection system including a head wall with a water outlet supplying a spring water collecting box as disclosed in U.S. Pat. No. 4,700,734 (McCauley), discussed above.

### SUMMARY OF THE INVENTION

The present invention is a pre-fabricated spring box, preferably of stainless steel. The steel spring box is an economical and convenient alternative for a concrete spring box poured at the spring site, which site is often remote or relatively inaccessible.

According to the present invention, the spring box has a stepped top, with a closed, raised top back portion, and an open, lowered top front portion, which front portion is covered and sealed by a snug hinged lid. The box is preferably constructed of medium gauge brushed stainless steel and is approximately 36″ tall, 36″wide and 24″ deep. The bottom of the box has an opening that is slightly smaller than the bottom. There is an identically sized opening in the back of the box near the bottom. A stainless steel cover panel of the size required to cover one of these openings is provided. Depending on the user's requirements, either the bottom of the box, or the opening in the back of the box, or both openings, may be left uncovered to allow spring water to fill the box from the bottom, the back, or from both directions.

The front of the box has three threaded couplers welded in place. These include a bottom drain, an outlet supply and an overflow. The bottom drain is near the bottom of the box, and is used to drain collected sediment from the lower portion of the box. The outlet supply line is near the center of the box, and is used to take collected water away from the box to a holding tank for further distribution. When the holding tank and/or the box are full, the overflow allows the box to discharge excess supply.

The invented spring box has a hinged lid that covers the lowered top front approximately 15″ of the top. The remaining approximately 9″ of the top is closed and raised approximately 6″ to provide a “curb” to keep ground material from moving forward and eventually covering the top of the box. Optionally, the box has a hinged hasp that can be used to lock the lid and secure the water supply. All seams between front, back, top, bottom and two side panels of the box are welded to be substantially water-tight. The total weight of the steel version of the box is approximately 110 pounds.

### BRIEF DESCRIPTION OF THE DRAWINGS

FIG. 1 is a front, top, and left side (when viewed from the back) perspective view of one embodiment of the spring box of the present invention with the top lid closed and locked.

FIG. 2 is a view similar to FIG. 1, but with the top lid unlocked and open.

FIG. 3 is a back, bottom and right side perspective view of the embodiment depicted in FIG. 1 with the back panel opened and the bottom panel closed.

FIG. 4 is a back view of the embodiment depicted in FIG. 3.

FIG. 5 is a back, bottom and left side perspective view of the embodiment depicted in FIGS. 3 and 4 with a drain line connected to the drain opening.

FIG. 6 is a back, bottom and right side perspective view of an alternative embodiment of the invention wherein the back panel is closed and the bottom panel is opened.

FIG. 7 is a front, top and left side perspective exploded view of the present invention with both back and bottom panel covers depicted.

FIG. 8 is a schematic, side cross-sectional view of one embodiment of the invention with an open back panel installed in a hillside with a spring.

### DETAILED DESCRIPTION OF THE INVENTION

Referring to the Figures, there is shown several, but not all, embodiments of the invented spring collector box.

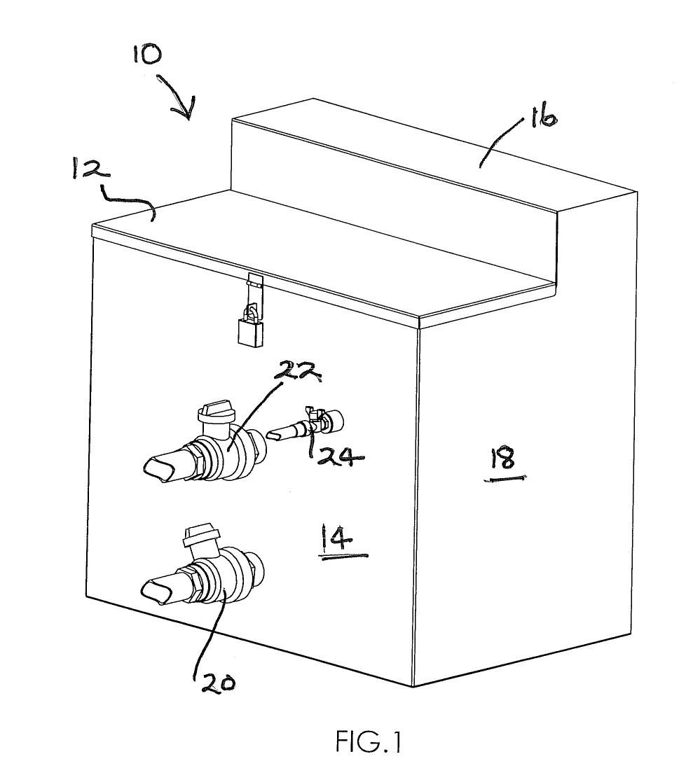

FIG. 1 is a front, top and left side (when viewed from the back) perspective view of one embodiment of the subject spring box 10, with the top lid 12 closed and locked. Spring box 10 has front panel 14, raised top back portion 16 and left side panel 18. Front panel 14 has drain line and valve 20, outlet supply line and valve 22, and overflow line and valve 24.

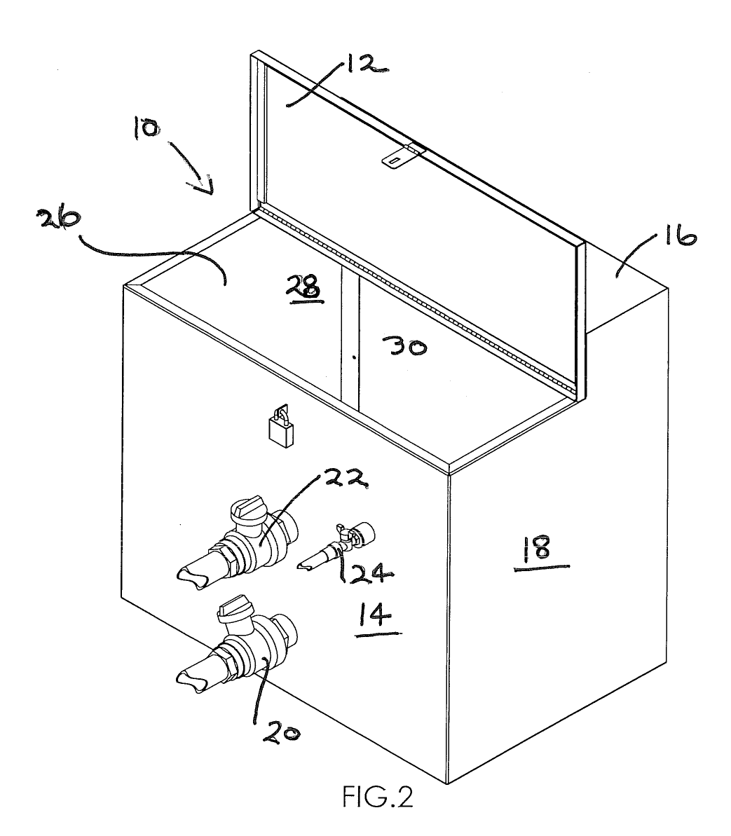

FIG. 2 is a view similar to FIG. 1, but with the top lid 12 unlocked and opened to reveal front portion opening 26, right side panel 28 and rear opening 30. Front top portion opening 26 allows for access for a work person to the interior of spring box 10 for inspection and maintenance.

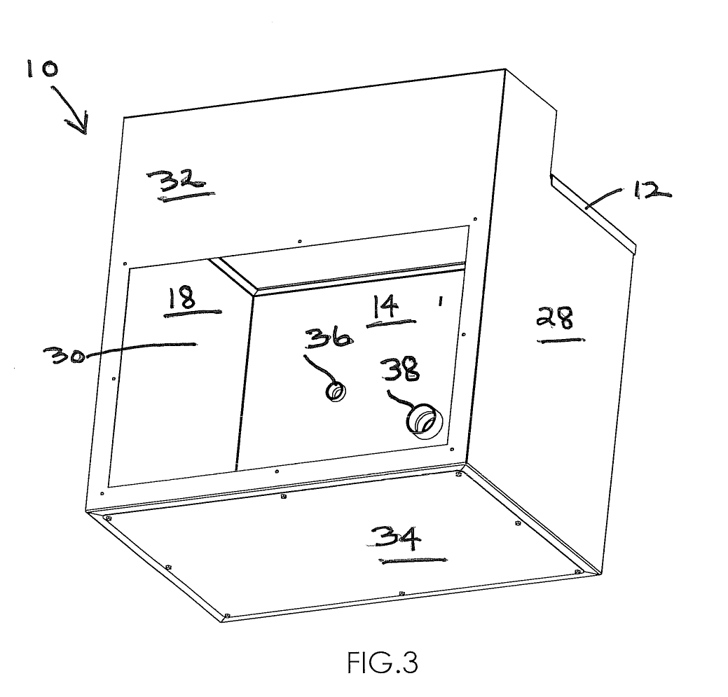

FIG. 3 is a back, bottom and right side perspective view of the spring box 10 depicted in FIG. 1, with the rear panel 32 opened with rear opening 30, and the bottom panel 34 closing the bottom opening. Through rear opening 30 are visible the coupling 36 for the overflow line and valve 24, and the coupling 38 for the outlet supply line and valve 22 in the front of panel 14.

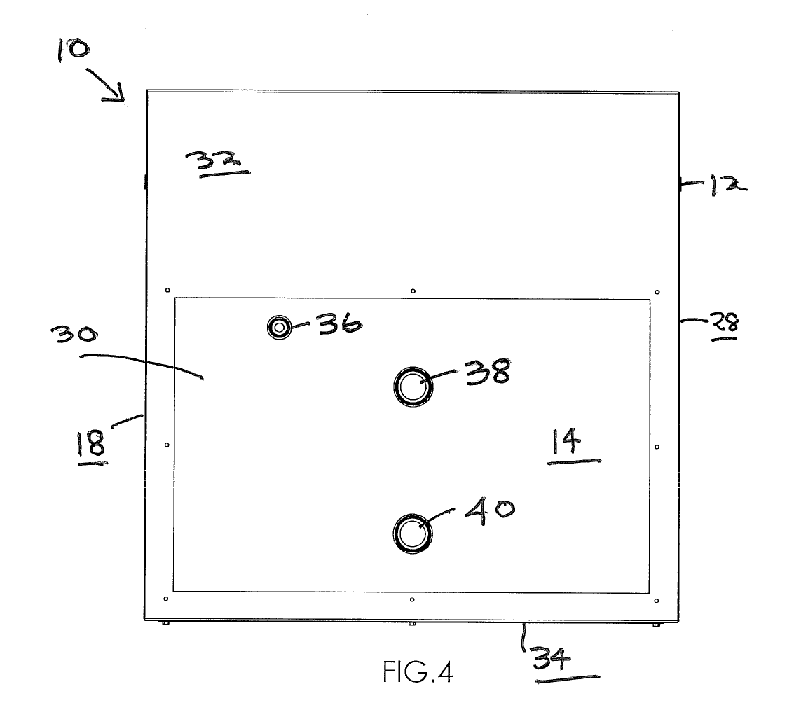

FIG. 4 is a back view of the embodiment depicted in FIG. 3, which back view newly shows the coupling 40 for the drain line and valve 20.

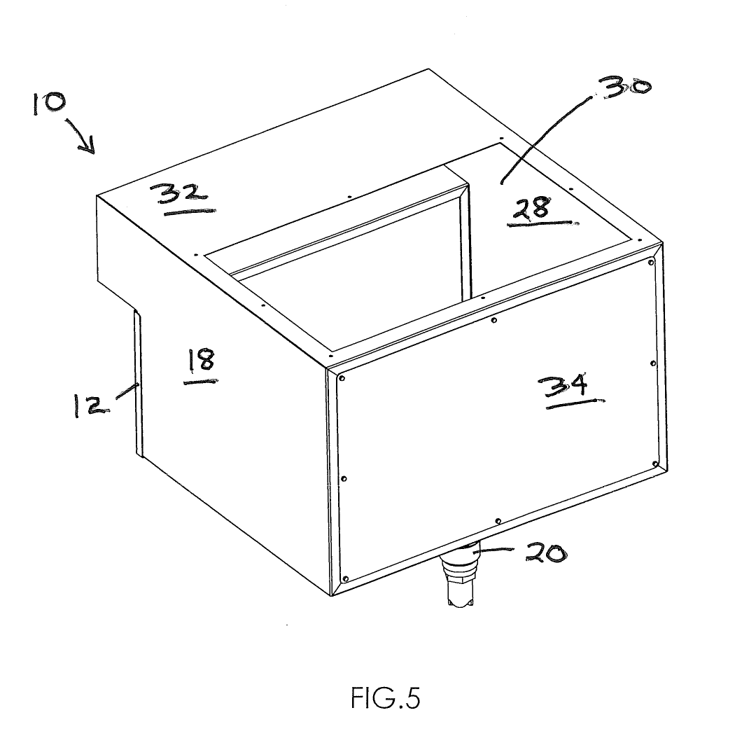

FIG. 5 is a back, bottom and left side perspective view of the embodiment depicted in FIGS. 3 and 4, with drain line and valve 20 being visible.

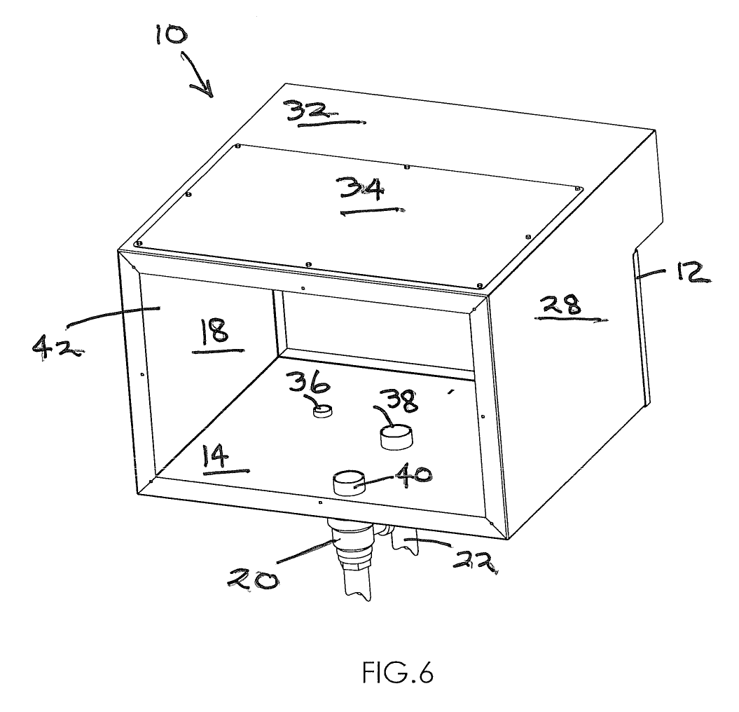

FIG. 6 is a back, bottom and right side perspective view of an alternate embodiment of the invention wherein the back panel 32 is closed by placing bottom panel 34 over what was the rear opening 30, creating bottom opening 42. In this Fig., drain line and valve 20 and outlet supply line and valve 22 are also visible.

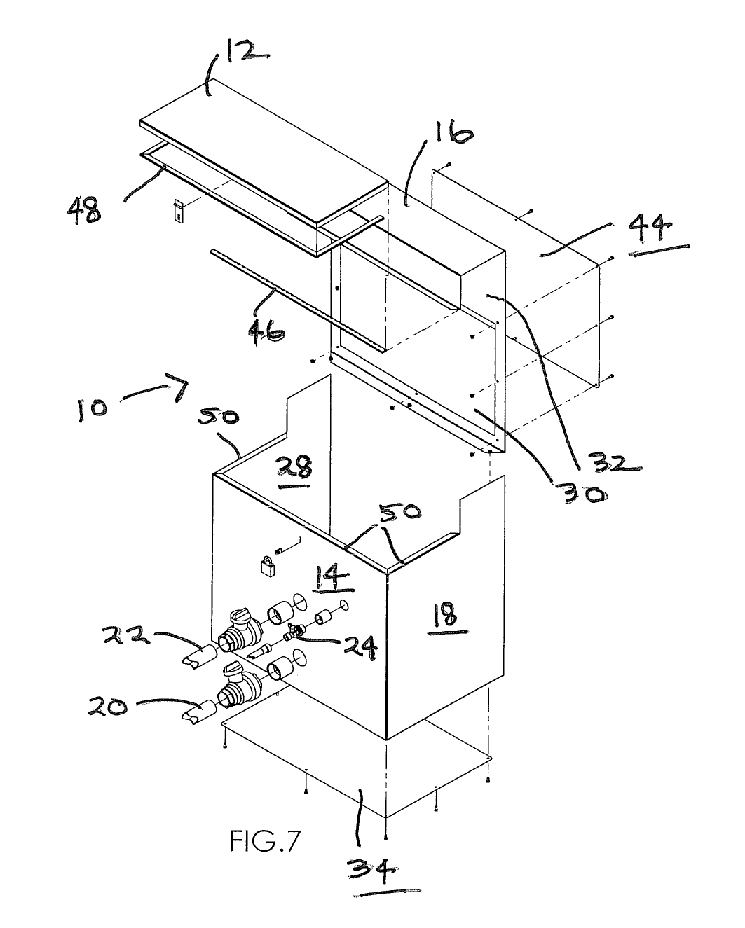

FIG. 7 is a front, top and left side perspective exploded view of the present invention with both bottom panel cover 34 and back panel cover 44 depicted. Newly depicted in this Figure is piano-style hinge 46 for connecting top lid 12 to raised top back portion 16, and gasket 48 for securely sealing top lid 12 to front top edge 50 formed by left side panel 18, front panel 14, and right side panel 28.

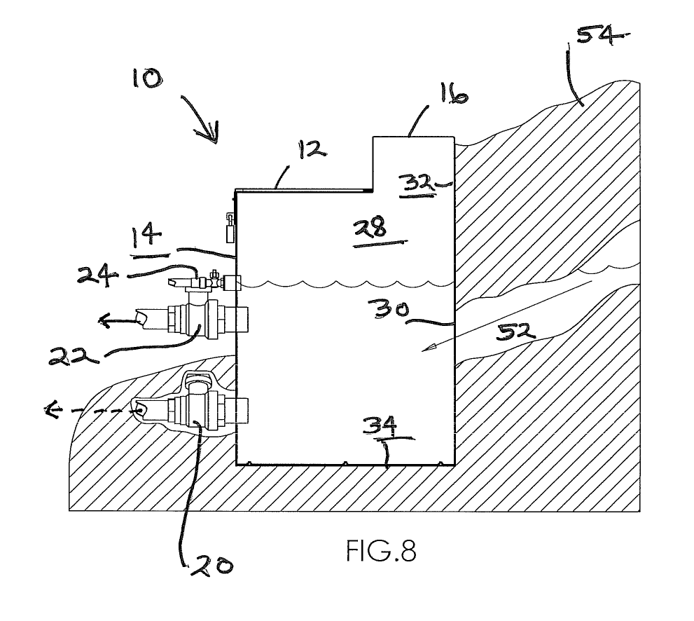

FIG. 8 is a schematic, side cross-sectional view of one embodiment of the invention with a rear opening 30 in communication with a spring 52 in hillside 54. Spring 52 flows from the hillside 54 as shown by the slanted arrow. Spring water fills the interior of spring box 10, generally up to the level of overflow line and valve 22, which is generally open. This way, collected spring water flows out from outlet supply line and valve 22, which is also generally open, as shown by the solid horizontal arrow. Drain line and valve 20 is normally closed. However, if sediment builds up in the bottom of the interior of the spring box 10, it may be removed by occasionally opening drain line and valve 20 to flush the sediment away, as depicted by the horizontal dashed arrow. Also, occasionally, top lid 12 may be unlocked and lifted open to provide access to the spring box 10 for inspection and removal of debris and sediment from the top of the spring box, as required or desired.

The spring collector box of the present invention may be made of any suitable material. Stainless steel is preferred. However, aluminum or other suitable metals and alloys may also be used, provided they are impervious and able to withstand the wet spring environment. Also, lightweight concrete or thin stone panels may also be used.

The spring collector box of the present invention may be entirely pre-fabricated at a site, like a manufacturing facility, remote from the spring site, and transported thereto. Also, the collector box may be partially pre-fabricated at a remote site, and conveniently transported to the spring site in pieces that may be securely assembled at the spring site.

Although this invention has been described above with reference to particular means, materials, and embodiments, it is to be understood that the invention is not limited to these disclosed particulars, but extends instead to all equivalents within the scope of the following claims.

I claim:

1. A spring collector box comprising:
a front panel, left and right side panels, back panel and bottom panel, all the panels being connected to at least three other panels;
the back panel and bottom panel both having an opening which is adapted to be covered by a cover panel;
the collector box also having a stepped top, with an open lower front portion and a closed higher back portion, the front portion having a snug, movable lid; and,
there being an opening in one of the front or side panels for an outlet supply line.

2. The collector box of claim 1, wherein the panels are welded to other panels.

3. The collector box of claim 1, wherein the openings in the back and bottom panels are the same size and shape.

4. The collector box of claim 3, wherein the openings are adapted to be covered by the same cover panel.

5. The collector box of claim 1, wherein the lid for the top lower front portion is connected to the top higher back portion by a hinge.

6. The collector box of claim 1, wherein the opening for the outlet supply line is in the front panel.

7. The collector box of claim 6, wherein the front panel also has an opening for a drain.

8. The collector box of claim 6, wherein the front panel also has an opening for an overflow.

9. The collector box of claim 1, wherein the openings for the outlet supply line, drain and overflow are all in the front panel.

10. The collector box of claim 1, wherein the bottom panel opening is covered by a cover panel and the back panel opening is not covered.

11. The collector box of claim 1, wherein the back panel opening is covered by a cover panel, and the bottom panel opening is not covered.

12. The collector box of claim 1, wherein neither the bottom panel nor the back panel is covered by a cover panel.

13. The collector box of claim 1, wherein the collector box panels are made of stainless steel.

14. The collector box of claim 1, wherein the collector is pre-fabricated in a remote location, and moved to a spring site in its fabricated condition.

15. A method for installing a spring collector box at a spring site, the spring box having front, back, top, bottom and two side panels, the method comprising:
pre-fabricating a collector box at a remote location; and
moving the fabricated collector box from the remote location to the spring site.

16. The method of claim 15, wherein the collector box is made of stainless steel.

17. The method of claim 15, wherein a spring inlet opening in the bottom panel is covered by a cover panel which also fits a spring inlet opening in the back panel, the back panel spring inlet opening being left uncovered.

18. The method of claim 15, wherein a spring inlet opening in the back panel is covered by a cover panel that also fits a spring inlet opening in the bottom panel, the bottom panel spring inlet opening being left uncovered.
